(19) United States
(12) Patent Application Publication
(10) Pub. No.: US 2025/0224277 A1
(43) Pub. Date: Jul. 10, 2025

(54) SHUTTERLESS NON-UNIFORMITY CORRECTION (NUC) AND CALIBRATION OF FOCAL PLANE ARRAYS

(71) Applicant: LightPath Technologies, Inc., Orlando, FL (US)

(72) Inventors: Shmuel RUBIN, Winter Park, FL (US); Jason LIEBERT, Nevada, TX (US)

(73) Assignee: LightPath Technologies, Inc., Orlando, FL (US)

(21) Appl. No.: 19/012,925

(22) Filed: Jan. 8, 2025

Related U.S. Application Data
(60) Provisional application No. 63/618,544, filed on Jan. 8, 2024.

(51) Int. Cl. G01J 5/80; G01J 5/00; G01J 5/20

(52) U.S. Cl. CPC G01J 5/80; G01J 2005/0077; G01J 2005/202

(57) ABSTRACT

A shutterless calibration for correcting an infrared focal plane array includes controlling an infrared calibration light source to output pulsed infrared light to be incident on the infrared focal plane array, comparing an image across the infrared focal plane array while illuminated with the pulsed infrared light with a reference image of the infrared focal plane array previously illuminated with the pulsed infrared light to detect non-uniformities across the infrared focal plane array, and storing detected non-uniformities across the infrared focal plane array to be used to correct the non-uniformities while imaging using the infrared focal plane array.

The present application claims priority to Provisional Ser. No. 63/618,544, filed on Jan. 8, 2024, the entire contents of which is incorporated herein by reference.

### BACKGROUND

### Field

The present disclosure relates to Non-Uniformity Correction (NUC) and Calibration of Focal Plane Arrays without the use of a mechanical shutter.

### Description of the Related Art

Uncooled Focal Plane Arrays, most commonly used in thermal imaging applications where cost, size and power are most important, are an array of microbolometer detectors. These microbolometer detectors, also referred to as pixels, are sensitive to thermal radiation. As thermal radiation from the scene strikes the infrared (IR) absorbing material of a pixel, the pixel will heat up and change resistance in proportion to the flux energy of irradiation. A Readout Integrated Circuit (ROIC) can measure the resistance changes of each pixel and translate them to intensity values that can be used to generate an image of the scene.

Uncooled thermal imagers do not have active temperature control and therefore the temperature of the sensor is allowed to drift as it operates in the ambient environment. The drifting temperatures cause pixel temperatures to vary (changing resistance) along with internal noise within the sensor cause non-uniformities across the array which can be seen in the image. These non-uniformities are often called (FPN) Fixed Pattern Noise, because they are generally very spatially consistent and change very slowly with time. FPN correction mostly involves correcting an offset, as the effect on gain is a small component thereof. Therefore, for correction only a single reference point is needed. To correct the FPN, most uncooled systems use a mechanical shutter that will close in front of the sensor to provide a single uniform scene reference for all pixels of the sensor. Mechanical shutters are very effective at correcting the non-uniformities in uncooled sensors due to thermal drift and internal noise and have been in use for many years.

However, mechanical shutters have several disadvantages. For example, mechanical shutters have the lowest MTBF (Mean Time Between Failures) of any other component in the uncooled sensor solution. Therefore, failure of mechanical shutters is the largest contributor to returns and field failures. Additionally, shutters are audibly noisy and can be a liability to users in applications where noise discipline is critical. Further, in operation, shutters block the view of the sensor for a period of time while the NUC operation is in work, losing valuable time that the sensor is not evaluating the scene. Further still, shutters require large amounts of power to activate in comparison to the rest of the sensor, often resulting in the sensor stopping operation as batteries are depleted. Finally, shutters are expensive and bulky.

In recent years companies producing detectors have developed some focal plane arrays that can operate without a shutter (shutterless). One shutterless approach uses characterization and calibration over temperature to maintain uniform images over time. However, this requires a highly characterized calibration with the specified optic that is going to be used and cannot be changed. This specific calibration requires extremely long calibration cycles, is labor intensive, requires expensive equipment, and results in long production cycles, limiting volume.

Another shutterless approach assumes that the sensor is going to be moving in operation and that the scene is sufficiently diverse, and using “temporal blurring of the scene across multiple pixels” to replicate a uniform scene. This may be realized by using an IMU (Inertial Measurement Unit) that uses a threshold of movement to determine sufficient blur of the scene and then will use that for calculating NUC. This is limited to specific cases where the movement causes the scene to change rapidly and the scene must be a diverse scene. Additionally IMU are expensive, heavy and require a significant amount of processing power to analyze and control.

### SUMMARY

One or more embodiments is directed to calibrating an infrared focal plane array.

According to embodiments, a method of calibrating an infrared focal plane array includes controlling an infrared calibration light source to output pulsed infrared light to be incident on the infrared focal plane array; comparing an image across the infrared focal plane array while illuminated with the pulsed infrared light with a reference image of the infrared focal plane array previously illuminated with the pulsed infrared light to detect non-uniformities across the infrared focal plane array; and storing detected non-uniformities across the infrared focal plane array to be used to correct the non-uniformities while imaging using the infrared focal plane array.

Controlling the pulsed infrared light source may include outputting pulsed infrared light having a length equal to one frame of a readout circuit of the infrared focal plane array.

A wavelength of the infrared calibration light source may be different from wavelengths to be imaged by the infrared focal plane array.

Controlling may further include diffusing the pulsed infrared light before being incident on the infrared focal plane array.

Controlling may further include directing the pulsed infrared light through an optical system for imaging on the infrared focal plane array.

Controlling may further include directing the pulsed infrared light to bypass an optical system for imaging on the infrared focal plane array.

Controlling may further include controlling the pulsed infrared light to have different intensities during different pulses.

The detected non-uniformities may be corrected for both an offset and a gain of the infrared focal plane array.

A non-transitory computer readable storage device having computer readable instructions that when executed by circuitry cause the circuitry to perform the method.

According to embodiments, an infrared calibration system for correcting an infrared focal plane array, includes a pulsed infrared calibration light source positioned relative to the infrared focal plane array such that pulsed infrared calibration light is incident on the infrared focal plane array; and an image processor. The image processor is configured to receive an image of the infrared focal plane array while illuminated with the pulsed infrared calibration light, compare the image across the infrared focal plane array while illuminated with the pulsed infrared light with a reference image of the infrared focal plane array to detect non-uniformities across the infrared focal plane array, and store detected non-uniformities across the infrared focal plane array to be used to correct images from the infrared focal plane array during imaging.

A wavelength of the infrared calibration light source may be different from wavelengths to be imaged by the infrared focal plane array.

The system may include a diffuser configured to diffuse the pulsed infrared light before being incident on the infrared focal plane array.

The pulsed infrared light may be incident on an optical system for imaging on the infrared focal plane array.

The pulsed infrared light is not incident on an optical system for imaging on the infrared focal plane array.

The pulsed infrared calibration light source may be within a housing of the infrared focal plane array.

The pulsed infrared calibration light source is on a side of and faces the infrared focal plane array.

The pulsed infrared calibration light source may be behind the infrared focal plane array and the system further includes a reflector to direct the pulsed infrared calibration light from the pulsed infrared calibration light source to the infrared focal plane array.

The image processor may be further configured to correct images from the infrared focal plane array during imaging using the stored detected non-uniformities.

The system may include an anti-reflective coating on at least one of a window to a housing of the infrared focal plane array and a lens in front of the infrared focal plane array.

The pulsed infrared calibration light source may vary an intensity output between pulses and the non-uniformities may be corrected for both an offset and a gain of the infrared focal plane array.

### BRIEF DESCRIPTION OF THE DRAWINGS

FIG. 1A illustrates a top view of a calibration system for a focal plane array according to an embodiment.

FIG. 1B illustrates a side view of a calibration system for a focal plane array according to an embodiment.

FIG. 2 illustrates a perspective view of a calibration system for a focal plane array according to another embodiment.

FIG. 3 illustrates a perspective view of a calibration system for a focal plane array according to another embodiment.

FIG. 4 illustrates a perspective view showing a positional relationship of elements of a calibration system for a focal plane array according to another embodiment.

FIG. 5 illustrates a perspective view showing a positional relationship of elements of a calibration system for a focal plane array according to another embodiment.

The scope of the present disclosure is best understood from the following detailed description of exemplary embodiments when read in conjunction with the accompanying drawings.

### DETAILED DESCRIPTION

Embodiments are directed to illuminating all pixels in a focal plane array with short pulses of light, which can then be used for non-uniformity correction. In particular, an infrared light source, e.g., an infrared light emitting diode (LED), that can be pulsed with controlled short pulses, illuminates the entire focal plane array momentarily. The light each pixel is illuminated with is then used to calculate the variance and change in that specific pixel since the last pulse of light. Using pulsed light instead of a mechanical shutter allows reduced power consumption, no audible noise, longer lifetime, smaller footprint, and lower cost. This calibration may be readily performed at predetermined time intervals, triggered based on a change in conditions, or a manual request. Further, reduced downtime may be realized since the light source can be pulsed to output light with very short pulses, e.g., the light source can illuminate the array for a time equal to as little as one frame (16.67 msec at 60 fps), significantly reducing the time the array is “blind”. In contrast, a shutter typically keeps the array blind for a period of 0.5 seconds (equivalent to 30 frames at 60 fps). As the blind time for the mechanical shutter includes time for the mechanical shutter to stabilize, even if the illumination is averaged over a number of frames for accuracy in the shutterless configuration, the blind time is still reduced. Also, the use of pulsed light allows calibration over two or more energy levels to be realized using the same process.

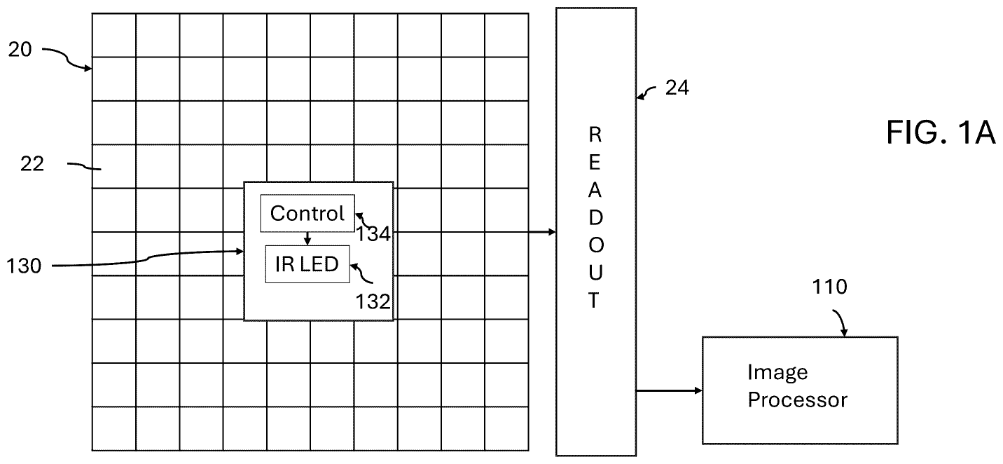

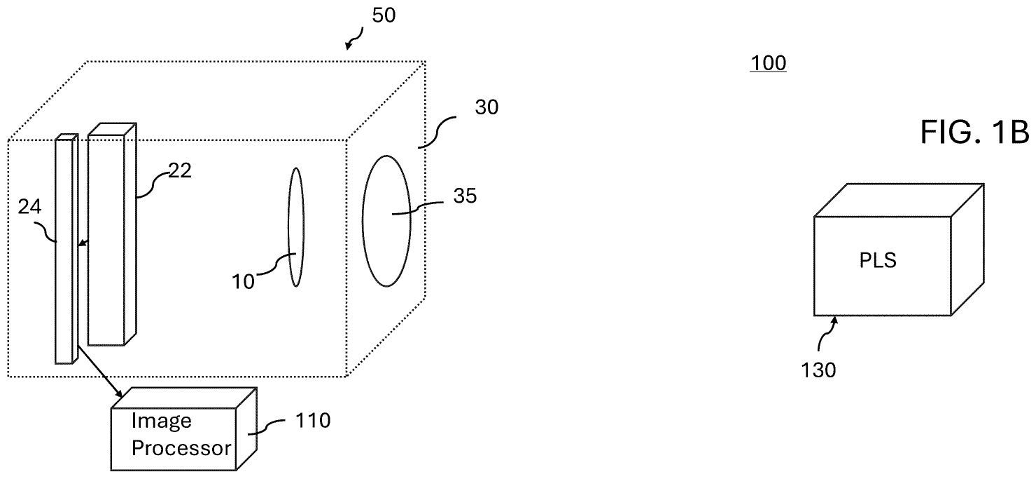

FIG. 1A is a top view and FIG. 1B is a perspective view of a calibration system 100 for a focal plane array (FPA) 20. The FPA 20 generally includes an array of light detectors 22, e.g., microbolometer detectors, also referred to as pixels, that are sensitive to thermal radiation and a readout circuit 24. For ease of illustration, the FPA 20 includes a 10 by 10 array of pixels, but this may be any array size, typically 640×480. The FPA 20 may be part of a detector 50 that includes a lens 10, and a housing 30 for the FPA 20 and the lens 10. The housing 30 is opaque to wavelengths to be detected by the FPA 20, and a window 35 in the housing 30 is transmissive for wavelengths to be detected by the FPA 20. The lens 10 may be part of an optical system including other powered optical elements.

The calibration system 100 includes an image processor 110 that stores a reference image output from the FPA 20 illuminated by a pulsed light source (PLS) 130 at an initial calibration. The image processor 110 then receives a calibration image output, e.g., a real-time calibration image, output from the readout circuit 24 of the FPA 20 when light from a pulsed light source (PLS) 130 is again incident on the FPA 20. The pulsed light source 130 includes an infrared light source 132 and a control circuit 134 the controls a pulse of light output by the light source 132. The image processor 110 may detect non-uniformities in the calibration image by comparing the calibration image to the reference image, store the detected non-uniformities and use the detected non-uniformities image to correct actual image output from the FPA 20 or provide the stored detected non-uniformities to another processor to correct images output from the FPA 20. The image processor 110 may be separated from the detector 50 or may be integrated with the detector, e.g., inside the housing 30. The real-time calibration may be performed at predetermined intervals based on a time or time of use and/or may be performed when a usage condition changes, e.g., temperatures vary by more than a predetermined amount, and/or a manual request for calibration.

As shown in FIGS. 1A and 1B, the PLS 130 can be outside of the detector 50 and placed in front of the FPA 20 to be incident thereon through the optical system 10. As long as each pixel is illuminated the same way each time (consistently and repeatably), the pixel level correction be realized even if the illumination is not uniform. In other words, as long as the illumination by the PLS 130 is stable over time, the illumination of the FPA 20 by the PLS 130 does not need to be uniform. Thus, by comparing the output of the FPA 20 illuminated with the PLS 130 over time, rather than an ideal, uniform illumination, non-uniformities arising due to changes in the FPA 20 may be compensated.

Further, light output by the PLS 130 may be the same as or different from target wavelengths to be detected by the detector 50, as long as the FPA 20 has sufficient sensitivity to that wavelength. For example, target wavelengths to be imaged by the detector 50 may be light at 8-12 μm, while the PLS 110 may output light at 7 μm. Additionally, the PLS 130 may be pulsed such that it emits two or more different intensities of light, so that a two-point or multi-point calibration of gain can be done in addition to the offset calibration. In particular, the control circuit 134 of the PLS 130, in addition to pulsing the infrared light source 132, may also control the intensity of the light output by the infrared light source 132 during different illumination periods. Thus, both gain and offset may be corrected using the same components, i.e., the PLS 130 and the image processor 110.

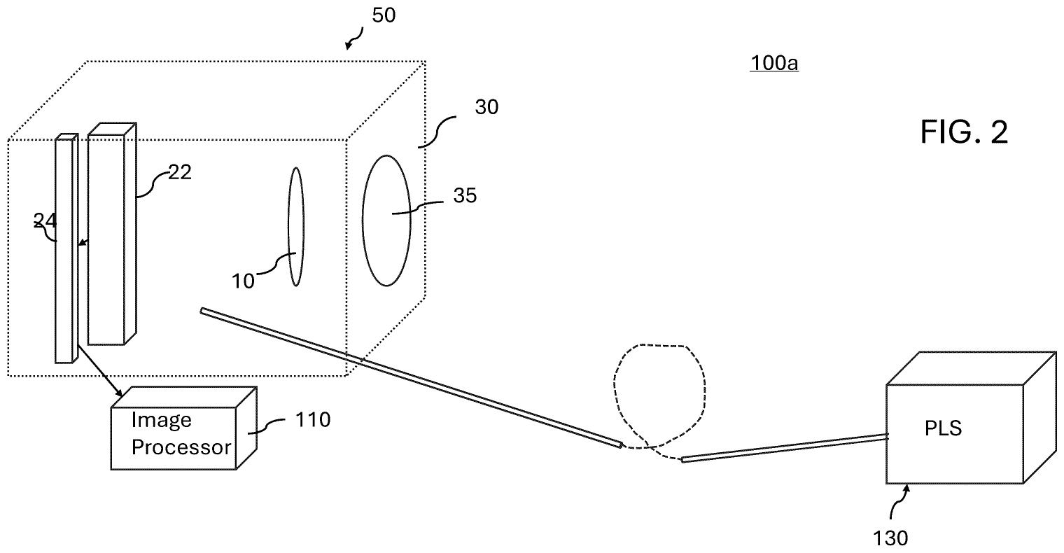

As shown in FIG. 2, a calibration system 100a may include the PLS 130 located remotely, light therefrom pointed the FPA 20 delivered over a fiber optic cable 132 or other waveguide like device, with the output of that fiber or waveguide pointed at the FPA 20 directly, i.e., without being incident on the window 135 or the lens 10. Alternatively, the PLS 130 may be delivered by the fiber optic cable 132 onto the window 135 or the lens 10.

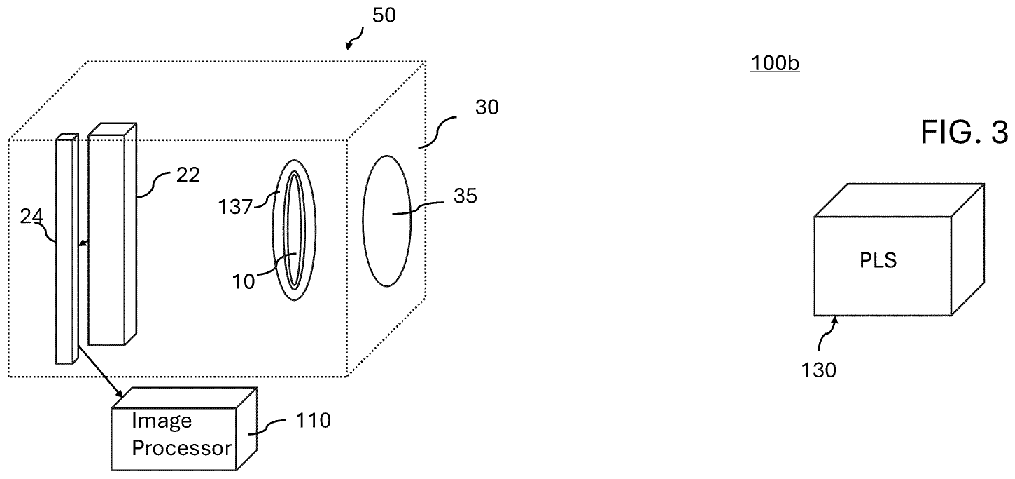

As shown in FIG. 3, a calibration system 100b may include a diffuser ring 138 that surrounds the lens 10 and diffuses light from the PLS 130 onto the FPA 20. The PLS 130 may output ring illumination to be incident on the diffuser ring 138.

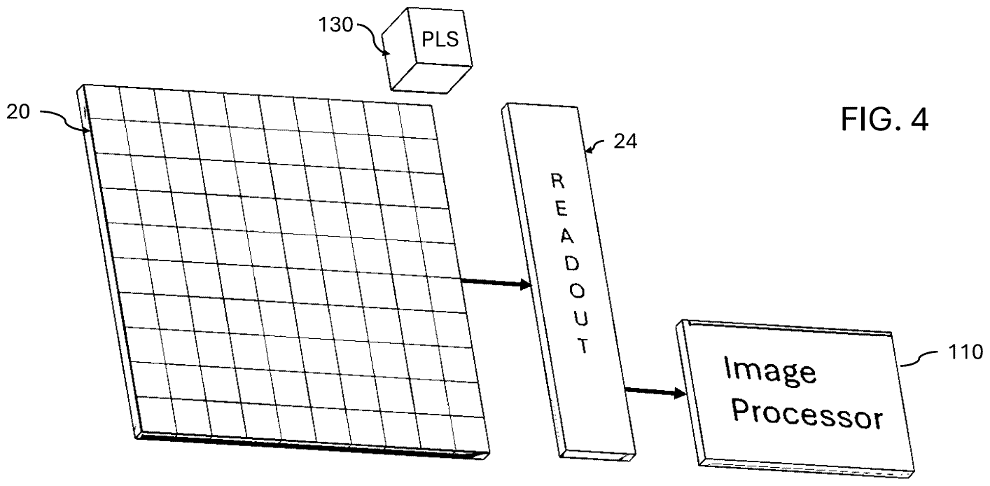

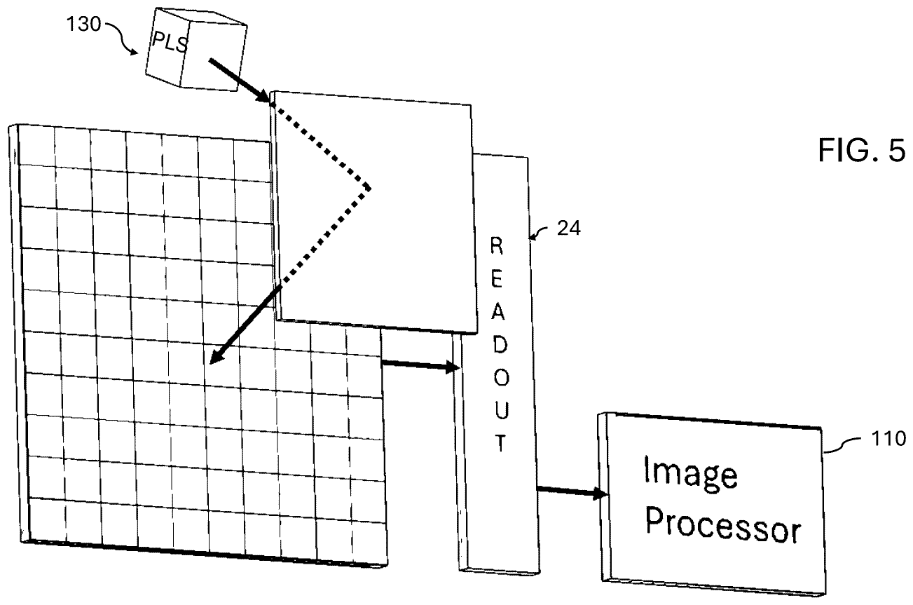

Alternatively, as shown in FIGS. 4 and 5, the PLS 130 may be provided in the housing 30 of the detector 50. For example, as shown in FIG. 4, the PLS 130 is mounted facing and to a side of the FPA 20. Alternatively, as shown in FIG. 5, the PLS 130 is mounted behind and at an angle to the FPA 20 and outputs light towards the lens 10 with a small reflector 140 (not shown to scale) between the lens 10 and the FPA 20 to reflect light from the PLS 130 onto the FPA 20. Further, the PLS 130 may include a plurality of light sources in the diffuser ring 138 of FIG. 3, i.e., within the housing 30 itself instead of an external light source shown in FIG. 3.

In any of the above embodiments, the lens 10 and/or window 35 of the detector 50 may be coated with a selective reflective coating, such that only the light from the PLS 130 is reflected back to the FPA 20. In another variation, in any of the above embodiments, the lens 10 and/or window 35 may be coated with a standard antireflective coating, yet a very small amount of light from the PLS 130 that will still be reflected off of that optical surface, would be sufficient for generating a calibration image for the non-uniformity correction.

The image processor 110 may include programable circuitry and a non-transitory computer readable medium for storing various programs and data. Further, while the image processor 110 and the control circuit 134 are illustrated as being separate, they may be incorporated into a single processor and/or may be remote from both the detector 50 and the infrared light source 132.

Thus, according to embodiments disclosed herein, calibration of a focal plane array using a pulsed light source may extend the useful lifetime of the focal plane array, reduce the cost of such calibration, reduce a size of the detector, relax requirements for such calibration, reduce audible noise, reduce blind time, and/or reduce power as compared to mechanical shutters.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure. The scope of the invention is indicated by the appended claims, rather than the foregoing description.

1. A method of calibrating an infrared focal plane array, comprising:
controlling an infrared calibration light source to output pulsed infrared light to be incident on the infrared focal plane array;
comparing an image across the infrared focal plane array while illuminated with the pulsed infrared light with a reference image of the infrared focal plane array previously illuminated with the pulsed infrared light to detect non-uniformities across the infrared focal plane array; and
storing detected non-uniformities across the infrared focal plane array to be used to correct the non-uniformities while imaging using the infrared focal plane array.

2. The method of claim 1, wherein controlling the pulsed infrared light source includes outputting pulsed infrared light having a length equal to one frame of a readout circuit of the infrared focal plane array.

3. The method of claim 1, wherein a wavelength of the infrared calibration light source is different from wavelengths to be imaged by the infrared focal plane array.

4. The method of claim 1, wherein controlling further includes diffusing the pulsed infrared light before being incident on the infrared focal plane array.

5. The method of claim 1, wherein controlling further includes directing the pulsed infrared light through an optical system for imaging on the infrared focal plane array.

6. The method of claim 1, wherein controlling further includes directing the pulsed infrared light to bypass an optical system for imaging on the infrared focal plane array.

7. The method of claim 1, wherein controlling further includes controlling the pulsed infrared light to have different intensities during different pulses.

8. The method of claim 7, wherein the detected non-uniformities are corrected for both an offset and a gain of the infrared focal plane array.

9. A non-transitory computer readable storage device having computer readable instructions that when executed by circuitry cause the circuitry to perform the method according to claim 1.

10. An infrared calibration system for correcting an infrared focal plane array, comprising:
a pulsed infrared calibration light source positioned relative to the infrared focal plane array such that pulsed infrared calibration light is incident on the infrared focal plane array; and
an image processor configured to
receive an image of the infrared focal plane array while illuminated with the pulsed infrared calibration light,
compare the image across the infrared focal plane array while illuminated with the pulsed infrared light with a reference image of the infrared focal plane array to detect non-uniformities across the infrared focal plane array, and
store detected non-uniformities across the infrared focal plane array to be used to correct images from the infrared focal plane array during imaging.

11. The infrared calibration system of claim 10, wherein a wavelength of the infrared calibration light source is different from wavelengths to be imaged by the infrared focal plane array.

12. The infrared calibration system of claim 10, further comprising a diffuser configured to diffuse the pulsed infrared light before being incident on the infrared focal plane array.

13. The infrared calibration system of claim 10, wherein the pulsed infrared light is incident on an optical system for imaging on the infrared focal plane array.

14. The infrared calibration system of claim 10, wherein the pulsed infrared light is not incident on an optical system for imaging on the infrared focal plane array.

15. The infrared calibration system of claim 10, wherein the pulsed infrared calibration light source within a housing of the infrared focal plane array.

16. The infrared calibration system of claim 15, wherein the pulsed infrared calibration light source is on a side of and faces the infrared focal plane array.

17. The infrared calibration system of claim 15, wherein the pulsed infrared calibration light source is behind the infrared focal plane array and the system further includes a reflector to direct the pulsed infrared calibration light from the pulsed infrared calibration light source to the infrared focal plane array.

18. The infrared calibration system of claim 10, wherein the image processor is further configured to correct images from the infrared focal plane array during imaging using the stored detected non-uniformities.

19. The infrared calibration system of claim 10, further comprising an anti-reflective coating on at least one of a window to a housing of the infrared focal plane array and a lens in front of the infrared focal plane array.

20. The infrared calibration system of claim 10, wherein the pulsed infrared calibration light source varies an intensity output between pulses and the detected non-uniformities are corrected both an offset and a gain of the infrared focal plane array.
